(19) United States
(12) Patent Application Publication
(10) Pub. No.: US 2023/0290923 A1
(43) Pub. Date: Sep. 14, 2023

(54) ELECTRODE INTENDED TO BE PLACED IN AN ELECTROCHEMICAL BUNDLE, ASSOCIATED BATTERY ELEMENT AND ASSOCIATED MANUFACTURING METHOD

(71) Applicant: SAFT, LEVALLOIS PERRET (FR)

(72) Inventors: Sébastien BADET, LE TAILLAN MEDOC (FR); Gilles PHILIPPE, IZON (FR)

(73) Assignee: SAFT, LEVALLOIS PERRET (FR)

(21) Appl. No.: 18/019,409

(22) PCT Filed: Aug. 6, 2021
(86) PCT No.: PCT/EP2021/071981

§ 371 Date: Feb. 2, 2023

(30) Foreign Application Priority Data
Aug. 7, 2020 (FR) FR2008361

(51) Int. Cl. H01M 4/04; H01M 4/485; H01M 4/131

(52) U.S. Cl. CPC H01M 4/0404; H01M 4/485; H01M 4/131

(57) ABSTRACT

The electrode comprises:
a support defining a first lateral edge and an upper edge extending from the first lateral edge;
a layer containing an active substance covering the support; and
an electrical-connection tab devoid of the layer containing the active substance, the tab projecting from the upper edge in the vicinity of the first lateral edge;

The electrode defines, in the vicinity of a second lateral edge of the support, a cutout extending, set back from the upper edge, in the continuation of the upper edge, towards the second lateral edge.

### CROSS REFERENCE TO RELATED APPLICATIONS

The present application is a U.S. National Phase application under 35 U.S.C. § 371 of International Patent Application No. PCT/EP2021/071981 filed Aug. 6, 2021, which claims priority of French Patent Application No. 20 08361 filed Aug. 7, 2020. The entire contents of which are hereby incorporated by reference.

### FIELD OF THE INVENTION

The present invention relates to an electrode of a first polarity, intended to be placed in an electrochemical bundle comprising at least one stack including the electrode of a first polarity, a separator, and an electrode of a second polarity, the electrode of a first polarity comprising:
a planar support, the support defining a first lateral edge and an upper edge extending from the first lateral edge;
a layer including an active substance, covering the support; and
an electrical connection tab, devoid of the layer containing the active substance, the tab projecting from the upper edge in the vicinity of the first lateral edge.

The invention is particularly applicable for electrochemical elements which use negative electrodes based on lithiated titanium oxide (LTO) or titanium niobium oxide (TNO) or any other active substance which carries no risk of lithium deposition and hence of formation of dendrites due to the high operating potential thereof.

### BACKGROUND

In such elements, the electrode bundle consists of an alternation of positive and negative electrodes which are stacked and isolated from each other by a separator between each pair of facing electrodes of opposite polarities.

Each electrode includes a metal support, e.g. made of aluminum, on which a layer containing the active substance is deposited. The layer containing the active substance of the negative electrode is placed facing the layer of the positive electrode, so as to optimize the electron exchanges and the electrochemical performance of the element.

To recover the voltage and the current, the bundle is connected in the upper part thereof to the terminals of the prismatic element via a weld on metal connections.

To this end, the positive electrodes each comprise a tab located on one side of the bundle, which protrudes with respect to the support provided with the active substance. Likewise, the negative electrodes include a plurality of tabs which are arranged on another side of the bundle with respect to the tabs of the positive electrodes.

When closing the housing of the element, so as to maximize the space occupied by the active substance inside the element, and the electrical capacity of the element, the lid which closes the element is likely to apply a stress on the connection, and consequently on the tabs of the electrodes.

The electrodes thus bend towards the stack and generally take a curved configuration. In such configuration, the tabs of the positive electrodes which are not coated with the layer containing the active substance are arranged in the vicinity of the upper edges of the supports of the negative electrodes.

Normally, the separator arranged between each pair of facing positive and negative electrodes is interposed between each tab of a positive electrode and the upper edge of the opposite negative electrode.

However, taking into account the compression within the element and the presence of the layer containing the active substance up to the upper edge of each negative electrode, there remains a substantial risk of short-circuit if insulation is poor, in particular if the separator does not form a screen, and/or if the electrical connections are heavily packed. In this way, the reliability of the battery cell is reduced.

To overcome such problem, it is known how to coat the base of the positive electrode tabs with a protective insulating coating such as a plastic or ceramic coating. However, such solution complicates the manufacturing process and increases the cost.

### SUMMARY

An aim of the invention is thus to provide, at a lower cost, an electrode for a bundle of electrodes of alternating polarities which is very reliable during the use thereof, while maintaining the electrical capacity and the compactness of the cell.

To this end, the subject matter of the invention is an electrode of a first polarity, as defined above, characterized in that the electrode of a first polarity defines, in the vicinity of a second lateral edge of the support, a cutout extending set back from the upper edge, in the continuation of the upper edge towards the second lateral edge.

The electrode according to the invention can comprise one or a plurality of the following features, taken individually or according to any technically possible combination:
a first polarity is a negative polarity;
the cutout extends as far as the second lateral edge;
the active substance contains a lithiated titanium oxide (LTO), or a titanium niobium oxide (TNO).

The invention further relates to an electrochemical bundle comprising at least one stack containing:
an electrode of a first polarity as defined above;
an electrode of a second polarity, containing a planar support, a layer containing an active substance covering the support, and an electrical connection tab, the support of the electrode of a first polarity being placed facing the support of the electrode of a second polarity; and
a separator interposed between the electrode of a first polarity and the electrode of a second polarity,

the tab of the electrode of a second polarity is placed facing the cutout.

The bundle according to the invention can comprise one or a plurality of the following features, taken individually or according to any technically possible combination:
the upper edge of the electrode of a second polarity is placed in the cutout at a height between the height of the upper edge of the electrode of a first polarity in the vicinity of the cutout and the height of a lower edge of the cutout;
the height separating the lower edge of the cutout and the upper edge of the electrode of a second polarity is greater than 1 mm;
the width of the cutout is greater than the width of the tab of the electrode of a second polarity;
a zone of the electrode of a second polarity extending facing the cutout, located between the upper edge of the electrode of a second polarity and the lower edge of the cutout is covered with the layer comprising the active substance;
said zone is more rigid, in particular under bending, than the tab;
no active substance of the active substance layer present on the electrode of a first polarity, is located facing said zone;
a lower zone of the tab above the upper edge of the electrode of a second polarity is covered with the layer comprising the active substance;
the height of the lower zone of the tab covered with the active substance is less than or equal to the height of the upper edge of the electrode of a first polarity.

A further subject matter of the invention is a battery cell, containing:
a housing or pouch delimiting an inner volume;
at least one electrode bundle as defined above, arranged inside the inner volume, the or each tab of the electrode of a second polarity protruding from the upper edge of the support of the electrode of a second polarity by being bent;
a connector attached onto the bent tab(s) of the electrode of a second polarity.

The battery cell according to the invention can further comprise one or a plurality of the features below, taken individually or according to all technically possible combinations:
the distance separating the lower edge of the cutout and the bending zone of each bent tab is greater than 10% of the height of the cutout, taken from the lower edge thereof to the upper edge of the electrode of a first polarity, in particular between 10% and 90% of the height of the cutout.
the distance between the lower edge of the cutout and the bending zone of each bent tab is greater than approximately 0.5 mm.
in a plane perpendicular to the support of the electrode of a first polarity, the or each tab of the electrode of a second polarity has a gooseneck shape;
the cell comprises a lid closing the housing, the connector including a terminal borne by the lid and a bent connection connecting the bent tab(s) of the electrode of a second polarity to the terminal.

A further subject matter of the invention is a manufacturing method for an electrode of a first polarity, comprising the following steps:
preparing a flat support and a lateral electrical connection tab, the support defining an upper edge from a first lateral edge of the support close to the tab, from which the tab protrudes;
depositing an ink containing an active substance over the support, the tab remaining devoid of the ink containing the active substance;

characterized by the following step:
forming a cutout extending in the vicinity of a second lateral edge of the support, set back from the upper edge, in the continuation of the upper edge towards the second lateral edge.

The manufacturing process according to the invention can include the following feature:
the support of each electrode of a first polarity is formed by at least one step of stamping a strip, the forming of the cutout being carried out during the step of stamping the strip intended to form the support.

### BRIEF DESCRIPTION OF THE DRAWINGS

The invention will be better understood upon reading the following description, given only as an example and making reference to the enclosed drawings, wherein:

FIG. 1 is a partial sectional view of a battery cell including at least one bundle of electrodes according to the invention;

FIG. 2 is a view of a negative electrode of the bundle according to the invention;

FIG. 3 is a view of a positive electrode according to the invention;

FIG. 4 is a view of a stack of negative electrodes, positive electrodes, and the separators in the bundle according to the invention;

FIG. 5 is a partial cross-sectional view of several electrode bundles, when the battery cell is placed in a housing;

FIG. 6 is an enlarged side view of the electrode connection zone, once the electrodes have been placed in the housing of a battery cell of the prior art;

FIG. 7 is a view similar to FIG. 6, of the connection zone of the electrodes, once the electrodes have been placed in the housing of a battery cell according to the invention.

### DETAILED DESCRIPTION

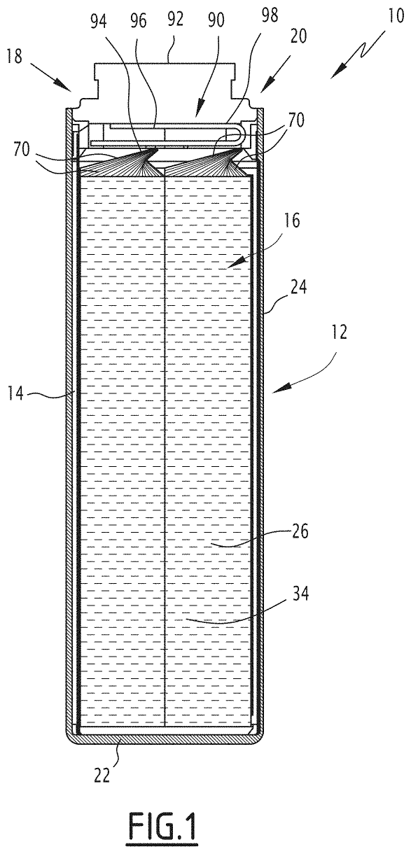

FIG. 1 partially illustrates a prismatic cell 10 of a battery according to the invention.

The battery is an electrochemical battery such as currently used in rail vehicles or in aircraft. However, other fields of application of the battery are conceivable, such as automotive vehicles, energy storage or electric mobility.

The cell 10 includes a casing or housing (or can) 12 defining an inner volume 14 and at least one bundle 16 of electrodes arranged inside the inner volume 14 of the housing 12.

The cell 10 further includes a lid 18 closing the inner volume 14 of the housing 12, and an electrical connector 20 electrically connected to the electrode bundle 16 and accessible on the lid 18.

As can be seen in FIG. 1, the housing 12 has a bottom wall 22 and a side wall 24 protruding from the bottom wall 22 so as to delimit the inner volume 14.

In the present example, the housing 12 has a parallelepiped shape, in particular a rectangular parallelepiped shape. The inner volume 14 of the housing 12 opens through an access opening which ends upwards, when the bottom wall 22 is placed on a horizontal support.

Thereinafter, the orientations are defined with reference to the housing 12 placed on a horizontal surface, with the bottom wall 22 thereof in contact with the horizontal surface. The terms “top”, “bottom”, “upper”, “lower”, “horizontal”, “vertical”, shall be understood in relation to the aforementioned orientation.

The lid 18 is intended to be attached onto the housing 12 so as to close the inner volume 14 upwards.

Each electrode bundle 16 is received in the inner volume 14. Preferentially, the volume occupied by the electrode bundle or bundles 16 is greater than 70% of the inner volume 14.

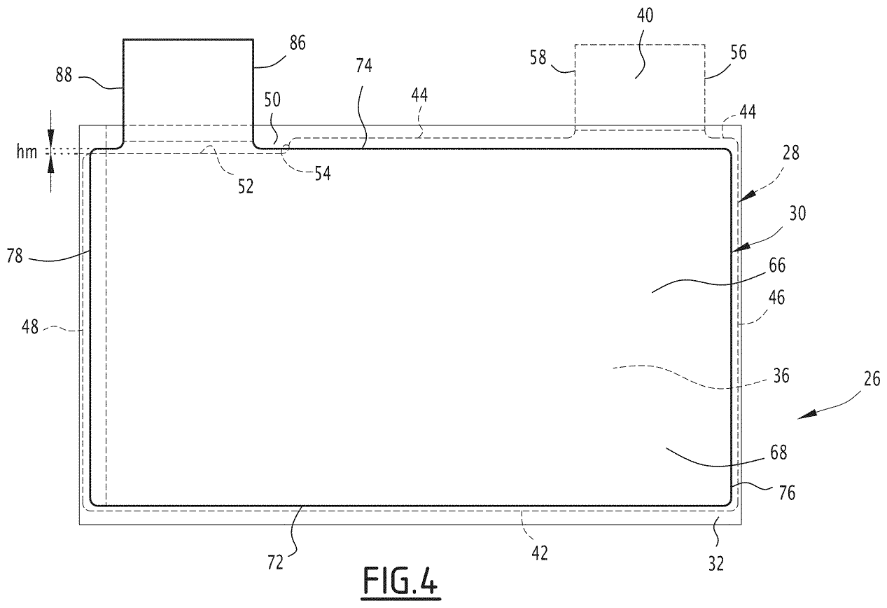

With reference, in particular, to FIGS. 1 and 4, each electrode bundle 16 includes at least one stack 26, preferentially a plurality of successive stacks 26, each including an electrode of a first polarity, in particular a negative electrode 28, an electrode of a second polarity, in particular a positive electrode 30, and a separator 32 interposed between the electrodes 28, 30.

Each electrode bundle 16 is further received in an electrolyte 34 present inside the inner volume 14 so as to impregnate the electrodes 28, 30 and the separator 32.

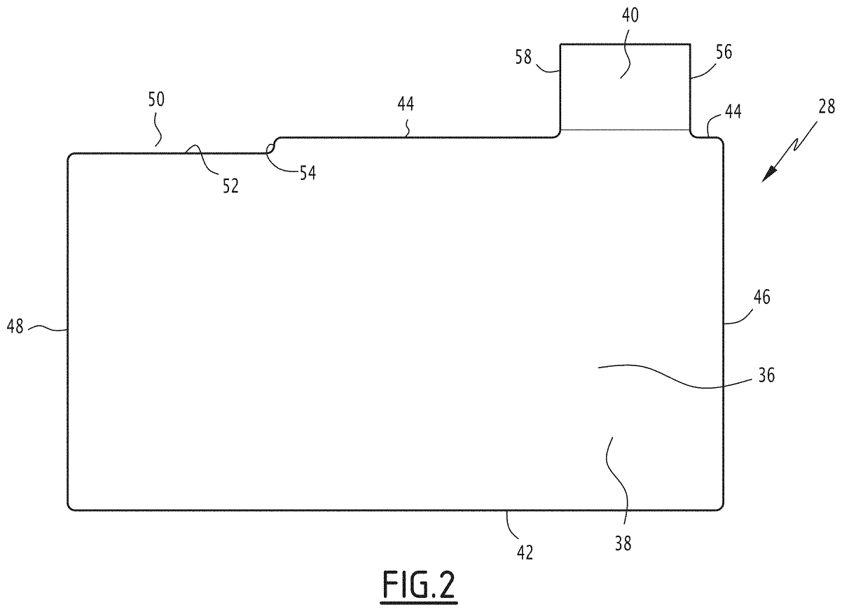

With reference to FIGS. 2 and 4, the electrode of a first polarity, herein the negative electrode 28, includes a plane support 36, a layer containing the active substance 38 covering the support 36 and a connection tab 40 protruding upwards with respect to the support 36 for connecting to the electrical connector 20.

The support 36 is preferentially made of metal. It forms a current collector. The support consists e.g. of a strip, in particular of a thin strip having a thickness of less than 20 μm. The support 36 is more particularly made of aluminum.

The support 36 has herein a substantially polygonal contour, in particular a rectangular contour. It extends vertically between a lower edge 42 and an upper edge 44. The support extends horizontally between a first lateral edge 46 located near the tab 40 (on the right in FIG. 2), and a second lateral edge 48 located opposite the tab 40 (on the left in FIG. 2).

In the present example, the upper edge 44 extends on both sides of the tab 40, which protrudes from the upper edge 44. The height at which the upper edge 44 extends with respect to the lower edge 42 is herein identical on both sides of the tab 40.

According to the invention, the support 36 further defines, near the second lateral edge 48, opposite the tab 40, an upper cutout 50, set back with respect to the upper edge 44.

The cutout 50 is delimited at the bottom by a lower edge 52 and laterally towards the tab 40, by a lateral edge 54.

In the present example, the depth of the cutout 50, taken vertically, is greater than 2 mm and is e.g. between 3 mm and 4 mm, preferentially between 3.2 mm and 3.6 mm.

As indicated above, the cutout 50 is set back from the upper edge 44. In particular, the height of the lower edge 52 of the cutout, taken vertically with respect to the lower edge 42, is less than the height of the upper edge 44, taken vertically with respect to the lower edge 42. Such is the case on both sides of the tab 40.

Advantageously, the cutout 50 extends as far as the second lateral edge 48 of the support 36.

The cutout has e.g. a width greater than the width of the tab 40, e.g. a width comprised between 105% to 160% of the width of the tab 40, taken horizontally. Such width is comprised e.g. between 40 millimeters and 50 millimeters.

The lower edge 52 of the cutout 50 is linked to the lateral edge 54 of the cutout 50 by a rounded portion with a concavity oriented downwards. The lateral edge 54 of the cutout 50 is linked to the upper edge 44 of the support 36 by a rounded portion, with a concavity oriented upwards.

The layer containing the active substance 38 covers the whole of at least one face of the support 36, vertically between the lower edge 42 and the upper edge 44, and horizontally between the lateral edge 48 and the lateral edge 46, as far as the edges 52, 54 of the cutout 50. The layer does not cover the tab 40 which remains bare.

The active substance 38 is e.g. a titanium oxide lithiated or capable of being lithiated (or “LTO”), or an oxide of titanium and niobium (or “TNO”) or alternatively a mixture of the two compounds (LTO/TNO).

Advantageously, titanium oxide lithiated or capable of being lithiated, is selected from the following oxides:
i) Liₓ₋ₐMₐTi_{y-b}M′bO_{4-c-d}X_{c}, wherein 0<x≤3; 1≤y≤2.5; 0≤a≤1; 0≤b≤1; 0≤c≤2 and 2.5≤d≤2.5;
wherein M represents at least one element chosen from the group consisting of Na, K, Mg, Ca, B, Mn, Fe, Co, Cr, Ni, Al, Cu, Ag, Pr, Y, and La;
M′ represents at least one element selected from the group consisting of B, Mo, Mn, Ce, Sn, Zr, Si, W, V, Ta, Sb, Nb, Ru, Ag, Fe, Co, Ni, Zn, Al, Cr, La, Pr, Bi, Sc, Eu, Sm, Gd, Ti, Ce, Y, and Eu;
X represents at least one element selected from the group consisting of S, F, CI, and Br;
the index d represents an oxygen vacancy, where the index d can be less than or equal to 0.5.
ii) HₓTi_{y}O₄ wherein 0≤x≤1; 0≤y≤2, and
iii) a mixture of the compounds i) to ii).

Examples of lithium titanium oxides belonging to group i) are spinel Li₄Ti₅O₁₂, Li₂TiO₃, ramsdellite Li₂Ti₃O₇, LiTi₂O₄, LiₓTi₂O₄, with 0<x≤2 and Li₂Na₂Ti₆O₁₄.

A preferred LTO compound has the formula Li₄₋ₐMₐTi_{5-b}M′_{b}O₄, e.g. Li₄Ti₅O₁₂, which is also written Li_{4/3}Ti_{5/3}O₄.

Examples of titanium and niobium oxide TNO have the formula general:

LiₓTi_{a-y}M_{y}Nb_{b-z}M′_{z}O_{((x+4a+5b)/2)-c-d}X_{c}
where 0≤x≤5; 0≤y≤1; 0≤z≤2; 1≤a≤5; 1≤b≤25; 0.25≤a/b≤2; 0≤c≤2 and 0≤d≤2; a−y>0; b−z>0;
M and M′ each represent at least one element selected from the group consisting of Li, Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd and Sm;
X represents at least one element selected from the group consisting of S, F, CI and Br.

The index d represents an oxygen vacancy. The index d can be less than or equal to 0.5.

Said at least one titanium and niobium oxide can be selected from TiNb₂O₇, Ti₂Nb₂O₇, Ti₂Nb₂O₉ and Ti₂Nb₁₀O₂₉.

The tab 40 protrudes upwards from the upper edge 44. In the present example, the tab is formed by being integral with the support 36.

The tab 40 has herein a polygonal contour, e.g. a rectangle or a square. The tab is linked at the base thereof along the sides 56, 58 thereof, to the upper edge 44, between a first region of the upper edge 44 adjacent to the lateral edge 46 and a second region of the upper edge 44 adjacent to the cutout 50. A rounded portion is formed between the upper edge 44 and each side 56, 58 of the tab 40.

The height of the rounded portion is e.g. greater than 0.5 mm and is comprised between 0.5 mm and 3 mm.

The distance horizontally separating a first side 56 of the tab 40 and the lateral edge 46 is preferentially less than the distance horizontally separating a second side 58 of the tab 40 and the lateral edge 54 of the cutout 50.

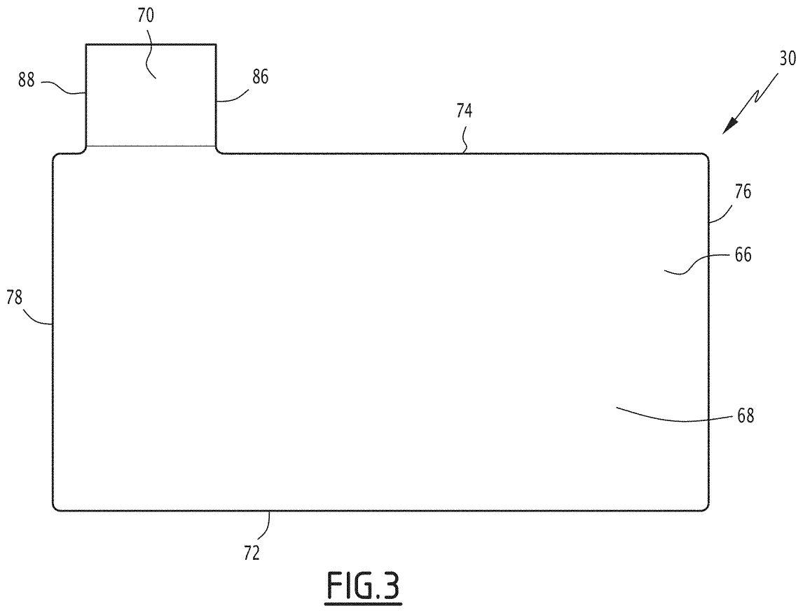

With reference to FIGS. 3 and 4, the electrode of a second polarity, herein the positive electrode 30, includes a plane support 66, a layer containing the active substance 68 covering the support 66 and a connection tab 70 protruding upwards with respect to the support 68 for connecting to the electrical connector 20.

The support 66 is preferentially made of metal. It forms a current collector. The support is formed e.g. of a strip, in particular of a thin strip having a thickness of less than 20 μm. The support 66 is more particularly made of aluminum.

The support 66 has herein a substantially polygonal contour, in particular a rectangular contour. As illustrated in FIG. 4, in the stack 26, the contour of the support 66 of the positive electrode 30 is preferentially inscribed in the contour of the support 36 of the negative electrode 28, with the exception of the cutout 50, when the electrodes 28, 30 are placed facing each other.

The support 66 extends vertically between a lower edge 72 and an upper edge 74. The support extends horizontally between a first lateral edge 76 located opposite the tab 70 (on the right in FIG. 2), and a second lateral edge 78 located near the tab 70 (on the left in FIG. 2).

In the present example, the upper edge 74 extends on both sides of the tab 70, which protrudes from the upper edge 74. The height at which the upper edge 74 extends with respect to the lower edge 72 is herein identical on both sides of the tab 70.

The layer containing the active substance 68 covers the whole of at least one face of the support 66, vertically between the lower edge 72 and the upper edge 74, and horizontally between the lateral edge 78 and the lateral edge 76. The layer does not cover the tab 70 which remains bare.

The active substance 68 can be selected from the following groups or the mixtures thereof: —a compound (a) with the formula LiₓM_{1-y-z-w}M′_{y}M″_{z}M′″_{w}O₂ (LMO₂) where M, M′, M″ and M′″ are selected from the group consisting of B, Mg, Al, Si, Ca, Ti, V, Cr, Mn, Fe, Co, Ni, Cu, Zn, Y, Zr, Nb, W, and Mo provided that at least M or M′ or M″ or M′″ is selected from Mn, Co, Ni, or Fe; M, M′, M″ and M′″ being different from each other; and 0.8≤x≤1.4; 0≤y≤0.5; 0≤z≤0.5; 0≤w≤0.2 and x+y+z+w<2.1; Such compound is e.g. a lithium nickel manganese cobalt (NMC) oxide or a lithium nickel cobalt aluminum (NCA) oxide;
a compound (b) with the formula LiₓMn_{2-y-z}M′_{y}M″_{z}O₄ (LMO), where M′ and M″ are selected from the group consisting of, Mg, Al, Si, Ca, Ti, V, Cr, Fe, Co, Ni, Cu, Zn, Y, Zr, Nb, and Mo; M′ and M″ being different from each other, and 1≤x≤1.4; 0≤y≤0.6; 0≤z≤0.2;
a compound (c) with the formula LiₓFe_{1-y}M_{y}PO₄ (LFMP) where M is selected from the group consisting of B, Mg, Al, Si, Ca, Ti, V, Cr, Mn, Co, Ni, Cu, Zn, Y, Zr, Nb, and Mo; and 0.8≤x≤1.2; 0≤y≤0.6;
a compound (d) with the formula LiₓMn_{1-y-z}M′_{y}M″_{z}PO₄ (LMP), where M′ and M″ are different from each other and are selected from the group consisting of B, Mg, Al, Si, Ca, Ti, V, Cr, Fe, Co, Ni, Cu, Zn, Y, Zr, Nb, and Mo, with 0.8≤x≤1.2; 0≤y≤0.6; 0≤z≤0.2;
a compound (e) with the formula xLi₂MnO₃; (1−x)LiMO₂ where M is at least one element selected from Ni, Co and Mn and x≤1.
a compound (f) with formula Li₁₊ₓMO_{2-y}F_{y} with a cubic structure where M represents at least one element selected from the group consisting of Na, K, Mg, Ca, B, Sc, Ti, V, Cr, Mn, Fe, Co, Ni, Cu, Zn, Al, Y, Zr, Nb, Mo, Ru, Ag, Sn, Sb, Ta, W, Bi, La, Pr, Eu, Nd, and Sm and where 0≤x≤0.5 and 0≤y≤1.

The tab 70 protrudes upwards from the upper edge 74. In the present example, the tab is formed by being integral with the support 66.

Herein, the tab 70 also has a polygonal contour, e.g. a rectangle or a square. The tab is linked at the base thereof along the sides 86, 88 thereof, to the upper edge 74, between a first region of the upper edge 74 adjacent to the lateral edge 76 and a second region of the upper edge 74 adjacent to the lateral edge 78. A rounded portion is formed between the upper edge 74 and each side 86, 88 of the tab 70.

The height of the rounded portion is e.g. greater than 0.5 mm and is comprised between 0.5 mm and 3 mm.

Within the stack 26, the support 66 of the positive electrode 30 extends facing the support 36 of the negative electrode 28, with the separator 32 interposed therebetween.

The upper edge 74 of the support 66 of the positive electrode 30 extends facing the cutout 50 at a height which is located between the height of the upper edge 44 of the support 36 of the negative electrode 28 and the height of the lower edge 52 of the cutout 50. As before, the heights are taken vertically from the lower edge 42 of the support 36 of the negative electrode 28.

The upper edge 74 has no cutout. It extends parallel to the lower edge 72 between the first lateral edge 76 and the second lateral edge 78.

With reference to FIG. 4, the height hm separating the base of the tab 70 from the positive electrode 30, taken at the level of the upper edge 74 of the positive electrode 30, and the lower edge 52 of the cutout 50 is greater than 1 mm, and preferentially comprised between 1 mm and 2 mm. Thus, the tab 70 of the positive electrode 30 is always located facing the cutout 50 provided in each support 36 of the negative electrode 28.

The width of the cutout 50 is greater than the width of the tab 70 of the electrode of a second polarity 30. The width of the cutout 50 is advantageously comprised between 105% and 160% of the width of the tab 70.

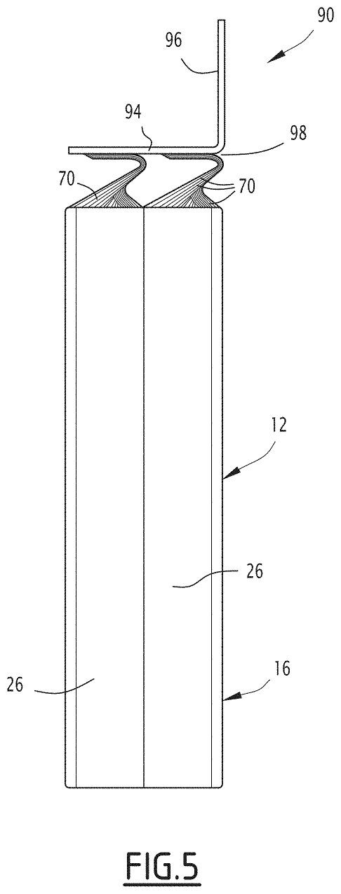

When the bundle 16 includes a plurality of successive stacks 26, as illustrated in FIGS. 1 and 5, the tabs 70 of the positive electrodes 30 of each stack 26 are joined to one another and are bent.

In a plane perpendicular to the plane of the supports 36, 66, the bending is in the form of a gooseneck.

Because of the presence of the cutouts 50, and despite such bending, the risk of contact between the bared tabs 70 and the negative electrodes 28 is very limited, even if the separator 32 does not provide electrical insulation.

Thereby, each tab 70 of a positive electrode 30 is able to be deformed when the bundle 16 is inserted into the housing 12, minimizing the risk of the tab 70 touching a negative electrode 28, since the tab 70 has space to bend within the cutout 50. The risk of short-circuit between the tab 70 of the positive electrode 30 and the support 36 of a negative electrode 28 is minimized, increasing the reliability of the cell 10.

Moreover, the positive electrode 30 can comprise a layer containing the active substance 68 over the entire flat support 66, without any risk of short-circuit, and without having to cover the zone at the base of the tab 70 with a protective coating preventing short-circuits.

The manufacture of the bundle 16 is thus simplified and less expensive. In addition, the weight of the bundle 16 is reduced. The capacity of the bundle 16 remains substantially identical to that of a bundle 16 of the prior art.

With reference to FIG. 4, the separator 32 consists of a sheet, preferentially an electrical insulating sheet. The sheet consists e.g. of a sheet of polymer material, in particular a sheet of polyolefin which is preferentially permeable to lithium ions.

The thickness of the separator 32 is e.g. less than 25 μm. Advantageously, the edges of the separator 32 protrude beyond the edges of the supports 36, 66 of the electrodes 28, 30.

The electrolyte 34 is e.g. liquid, e.g. consisting of an organic electrolyte containing lithium salts such as LiPF₆, and solvents. As a variant, the electrolyte 34 is in the form of a solid or a gel, e.g. based on polyvinylidene fluoride (PVDF) polymers or a polyvinylidene fluoride-hexafluoropropylene (PVDF-HFP) copolymer, as well as of solvents and salts.

The electrical connector 20 includes a bent connection 90 attached to the tabs 70 of the positive electrodes 30, and a terminal 92 mounted on the lid 18, the terminal 92 being connected to the bent connection 90.

With reference to FIG. 1 and to FIG. 5, the bent connection 90 includes a first flank 94, attached to the tabs 70, a second flank 96, movable with respect to the first flank 94, in electrical contact with the terminal 92, and a bend 98 connecting the flanks 94, 96.

The bent connection 90 is e.g. made of metal, in particular aluminum. The tabs 70 of the positive electrode 30 are e.g. attached to the first flank 94, by welding.

The bend 98 between the first flank 94 and the second flank 96 provides a permanent force applied to the tabs 70 towards the supports 36, 66, so as to make the stacks 26 compact inside the housing 12. Thereby, the filling of the housing 12 is maximized, and the quantity of active substance 38, 68 present within the housing 12 is maximum, providing maximum capacity.

The manufacture of the cell 10 will now be described. Initially, the supports 36, 66 are manufactured by unfolding length of metal strip, and by carrying out stamping steps for producing the contour of each of the supports 36, 66 and of the respective tabs 40, 70.

The cutout 50 in the support 36 intended to form each negative electrode 28 is provided during an already existing stamping step, e.g. during the stamping step implemented for producing the upper edge 44. In this way, the number of steps for producing cutout 50 is not increased.

Each of the supports 36, 66 is then coated with an ink containing in particular the active substance 38, 68, so as to form each electrode 28, 30. The tabs 70 are not coated with ink comprising the active substance. Advantageously, the ink further contains a binder and an electronically conducting compound. The deposit forms the layer containing the active substance 38, 68.

The stacks 26 are then produced, by arranging a negative electrode 28 facing a positive electrode 30, with the interposition of a separator 32.

During such embodiment, the tab 70 of the positive electrode 30 is placed facing the cutout 50 of the negative electrode 28. All the tabs 70 of the positive electrodes 30 are then located facing one another, and in a region of the negative electrodes 28 having cutouts 50, thus freeing a space for bending the tabs 70.

The packing phenomenon as in this way reduced, since the tabs 70 of the positive electrodes 30 have a greater free length.

The tabs 70 of the positive electrodes 30 of each stack 26 are then joined to one another by the free ends thereof. The tabs are then bent in the form of a gooseneck, as illustrated in FIG. 5. The free ends of the interconnected tabs 70 are then attached to the first flank 94 of the bent connection 90.

The bent connection then occupies an open L-shaped configuration, the second flank 96 being substantially parallel to the first flank 94.

The electrode bundle 16, on which the bent connection 90 is mounted, is then introduced into the inner volume 14 of the housing 12.

The lid 18, provided with the terminal 92, is then placed above the bent connection 90. The connection 90 bends at the bend 98 so as to place the second flank 96 facing the first flank 94, the bent connection 90 then having a U-shaped configuration. During the bending, the compactness in the inner volume 14 is maximized.

Due to the presence of the cutouts 50, the tabs 70 of the positive electrodes 30 do not cross the active substance 38 of the negative electrodes 28.

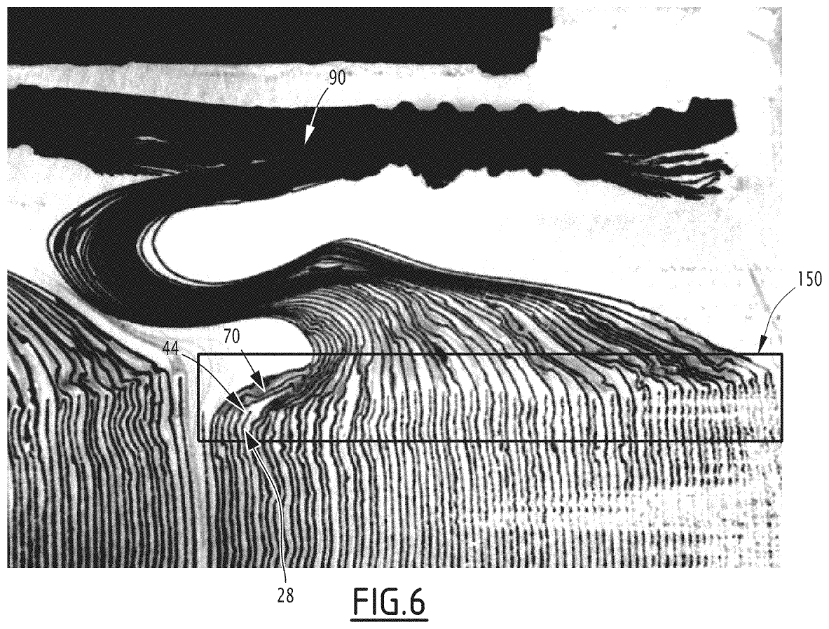

As an illustration, FIG. 6 is a side view of a battery cell of the prior art wherein the negative electrodes 28 have no cutouts 50. There is a risk of short-circuit in the bending zone 150 of the tabs 70 of the positive electrodes which pass just above the upper edges 44 of the negative electrodes 28.

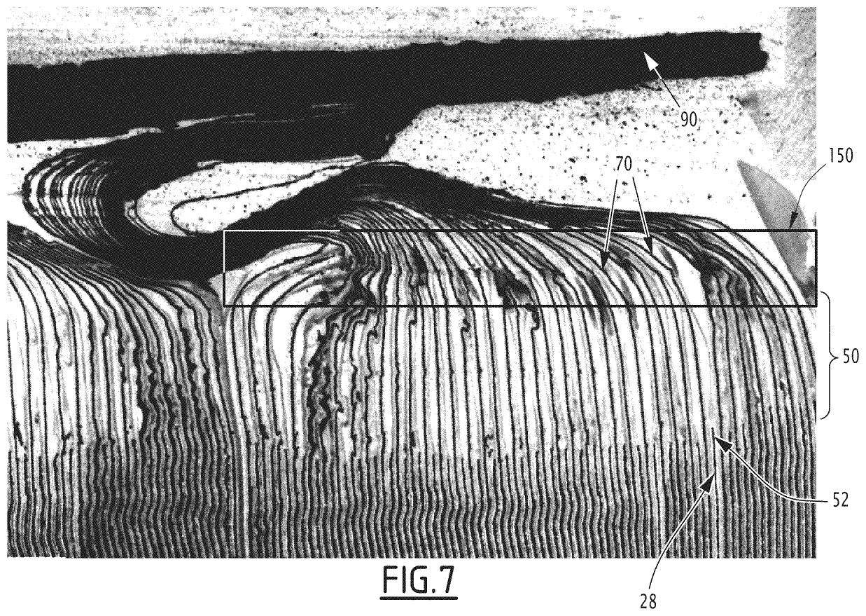

On the other hand, as illustrated in FIG. 7, in a battery cell 10 according to the invention, the presence of the cutouts 50 eliminates the risk of contact between the bent tabs 70 and the negative electrodes 28, in the bending zone 150.

Short-circuits are in this way prevented in the bending zone of the tabs 70, providing a reliable operation of the cell 10. Such result is obtained without having to increase the manufacturing cost of the negative electrodes 28, since the cutout 50 is formed during the usual steps of manufacturing of the electrodes 28.

Furthermore, the negative electrodes 28 are made lighter, leading to a general lighter weight of the electrode bundle 16 and hence of the cell 10.

The reduction of the capacity of the cell 10 resulting from the presence of the cutouts 50 is less than 1%, preferentially less than 0.5%.

In a variant, the housing 12 is replaced by a flexible pouch containing the electrode bundle 16 described above.

As indicated above, the zone of the positive electrode 30 extending facing the cutout 50, located between the upper edge 74 of the support 66 of the positive electrode 30, under the tab 70 and the lower edge 52 of the cutout 50, is covered with the active substance 68.

Thereby, such zone is more rigid, in particular under bending, than the tab 70. Thus, as can be seen in FIG. 7, it remains substantially vertical, without bending, whenever the tab 70 is bent.

No active substance of the active substance layer 38 present on the negative electrode 28 is located facing said zone.

In this way, such stiffened zone moves the bending zone 150 of each tab 70 away from the lower edge 52 of the cutout 50 provided in each negative electrode 28.

The distance, separating the lower edge 52 of the cutout 50 and the bending zone 150 generally being greater than 10% of the height of the cutout 50 taken from the lower edge 52 thereof to the upper edge 54, in particular is comprised between 10% and 90% of the height of the cutout 50.

Such distance is e.g. greater than approximately 0.5 mm.

The height at which the bending zone 150 begins is the height at which, in section in a plane perpendicular to the support 66 of the positive electrode 30 (which corresponds to the plane of FIG. 7), the angle between the tangent to the tab 70 and the tangent to the support 66 is greater than 10°.

Thereby, as indicated above, the risk of contact between the bent tabs 70 and the negative electrodes 28 in the bending zone is eliminated, due to the separation produced on the bending zone of the tabs 70.

In a variant, a lower zone of the tab 70 located above the upper edge 74 of the support 66 of the positive electrode 30 is also covered with the active substance 68.

The height of the lower zone of the tab 70 covered with the active substance 68 is then preferentially less than or equal to the height of the upper edge 44 of the support 36 of the negative electrode 28.

1. An electrode of a first polarity, to be placed inside an electrochemical bundle comprising at least one stack including the electrode of a first polarity, a separator, and an electrode of a second polarity, the electrode of a first polarity comprising:
a first planar support, the first planar support defining a first lateral edge and an upper edge extending from the first lateral edge;
a first layer containing an active substance, covering the first planar support; and
an electrical connection first tab, devoid of the layer containing the active substance, the first tab protruding from the upper edge in the vicinity of the first lateral edge;
the electrode of a first polarity defining, in the vicinity of a second lateral edge of the first planar support, a cutout extending; set back from the upper edge, in a continuation of the upper edge towards the second lateral edge.

2. The electrode of a first polarity according to claim 1, wherein the first polarity is a negative polarity.

3. The electrode of a first polarity according to claim 1, wherein the cutout extends as far as the second lateral edge.

4. The electrode of a first polarity according to claim 1, wherein the active substance contains lithium titanium oxide, or niobium titanium oxide.

5. An electrochemical bundle comprising at least one stack containing:
an electrode of a first polarity according to claim 1, and
an electrode of a second polarity, containing a second planar support, a second layer containing an active substance covering the second planar support, and an electrical connection second tab, the first planar support of the electrode of a first polarity being placed facing the second planar support of the electrode of a second polarity; and
a separator interposed between the electrode of a first polarity and the electrode of a second polarity,
the second tab of the electrode of a second polarity being placed facing the cutout.

6. The electrode bundle according to claim 5, wherein an upper edge of the electrode of a second polarity is placed in the cutout at a height between (i) a height of the upper edge of the electrode of a first polarity in the vicinity of the cutout and (ii) a height of a lower edge of the cutout.

7. The electrode bundle according to claim 6, wherein at least a zone of the electrode of a second polarity extending facing the cutout, located between the upper edge of the electrode of a second polarity and the lower edge of the cutout, is covered with the layer containing the active substance.

8. The electrode bundle according to claim 7, wherein a lower zone of the tab above the upper edge of the electrode of a second polarity is also covered with the layer comprising the active substance.

9. The electrode bundle according to claim 5, wherein a height separating the lower edge of the cutout and the upper edge of the electrode of a second polarity is greater than 1 mm.

10. The electrode bundle according to claim 5, wherein a width of the cutout is greater than a width of the second tab of the electrode of a second polarity.

11. The battery cell, containing:
a housing or a pouch delimiting an inner volume;
at least one electrode bundle according to claim 5, arranged inside the inner volume, the second tab of the electrode of a second polarity protruding from the upper edge of the second planar support of the electrode of a second polarity by being bent; and
a connector attached to the bent second tab of the electrode of a second polarity.

12. The battery cell according to claim 11, wherein in a plane perpendicular to the first planar support of the electrode of a first polarity, the bent second tab of the electrode of a second polarity has a gooseneck shape.

13. The battery cell according to claim 11, comprising a lid losing the housing, the connector including a terminal borne by the lid and a bent connection connecting the bent second tab of the electrode of a second polarity to the terminal.

14. A method of manufacturing an electrode of a first polarity, comprising:
preparing a first planar support and a lateral electrical connection first tab, the first planar support defining an upper edge from a first lateral edge of the support close to the first tab, from which the first tab protrudes;
depositing an ink containing an active substance over the first planar support, the first tab remaining devoid of the ink containing the active substance; and
forming a cutout extending in the vicinity of a second lateral edge of the first planar support, the cutout being set back from the upper edge in the continuation of the upper edge towards the second lateral edge.

15. The method according to claim 14, further comprising a step of forming the first planar support of each electrode of a first polarity by stamping a strip, the forming of the cutout being carried out during stamping the strip intended to form the first planar support.
